(19) United States
(12) Patent Application Publication
(10) Pub. No.: US 2014/0184181 A1
(43) Pub. Date: Jul. 3, 2014

(54) POWER GOOD SIGNAL GENERATION CIRCUIT

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventor: HAI-QING ZHOU, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 14/141,386

(22) Filed: Dec. 26, 2013

(30) Foreign Application Priority Data
Dec. 27, 2012 (CN) 2012105774828

(51) Int. Cl. H02M 1/00

(52) U.S. Cl. CPC H02M 1/00
USPC 323/271

(57) ABSTRACT

A power good signal generation circuit includes first and second resistors, a comparator, and first and second electronic switches. A power source is grounded through the first and second resistors. A non-inverting input of the comparator is connected to a power circuit. An inverting input of the comparator is connected between the first and second resistors. The comparator output controls the first electronic switch and the first electronic switch controls the operation of the second electronic switch. When the power circuit is operating properly, the power good signal generation circuit outputs a high level signal indicating power good, but when the power circuit is not operating properly a low level signal indicating power not good is output.

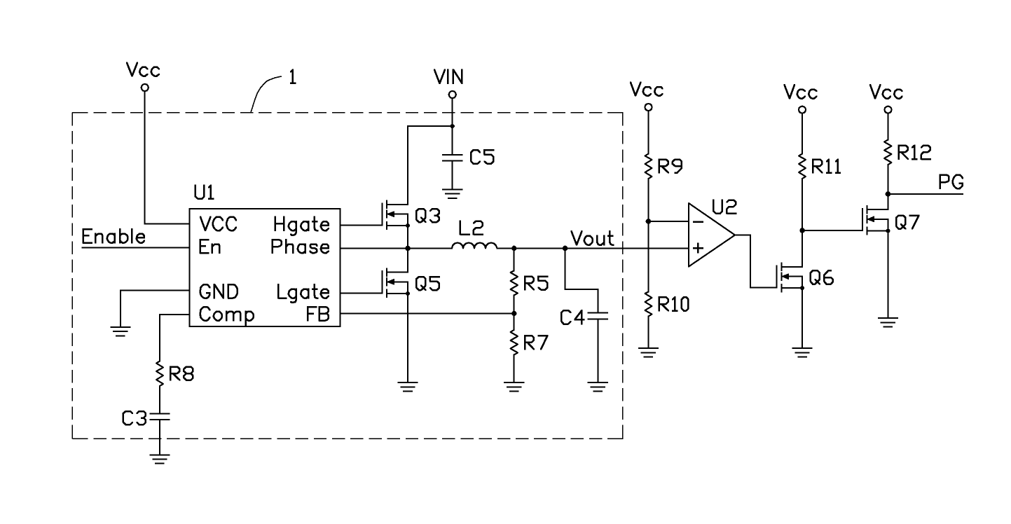

### BACKGROUND

1. Technical Field

The present disclosure relates to a power good signal generation circuit.

2. Description of Related Art

Power good signals output by chips to a motherboard indicate that the chips are ready to operate or are operating normally. The motherboard outputs control signals to control the chips corresponding to the power good signals. However, a plurality of chips used in power management cannot output power good signals, which makes it difficult for the motherboard to control the chips.

Therefore, there is room for improvement in the art.

### BRIEF DESCRIPTION OF THE DRAWING

Many aspects of the present disclosure can be better understood with reference to the drawing. The components in the drawing are not necessarily drawn to scale, the emphasis instead being placed upon clearly illustrating the principles of the present disclosure.

The FIGURE is a circuit diagram of an embodiment of a power good signal generation circuit of the present disclosure.

### DETAILED DESCRIPTION

The power good signal generation circuit is connected to a power circuit 1. When the power circuit 1 is operating normally, the power good signal generation circuit outputs a power good signal PG.

The power circuit 1 comprises a power chip U1, a metal oxide semiconductor field effect transistor (MOSFET) Q3, a MOSFET Q5, and an inductor L2. The power chip U1 comprises a power pin VCC, an enable pin En, a ground pin GND, a programming pin Comp, a high gate output pin Hgate, a low gate output pin Lgate, a phase output pin Phase, and a feedback pin FB. The power good signal generation circuit comprises a MOSFET Q6, a MOSFET Q7, and a comparator U2.

The power pin VCC of the power chip U1 is connected to a power source Vcc. The enable pin En of the power chip U1 receives an enable signal. The ground pin GND of the power chip U1 is grounded. The programming pin Comp of the power chip U1 is grounded through a resistor R8 and a capacitor C3 in that order. The high gate output pin Hgate of the power chip U1 is connected to a gate of the MOSFET Q3. The low gate output pin Lgate of the power chip U1 is connected to a gate of the MOSFET Q5. A drain of the MOSFET Q3 is connected to a power source VIN. The drain of the MOSFET Q3 is also grounded through a capacitor C5. A source of the MOSFET Q3 is connected to the phase output pin Phase of the power chip U1. A source of the MOSFET Q5 is grounded. A drain of the MOSFET Q5 is connected to the phase output pin Phase of the power chip U1.

The phase output pin Phase of the power chip U1 is connected to a non-inverting input of the comparator U2 through the inductor L2. The non-inverting input of the comparator U2 is also grounded through a resistor R5 and a resistor R7 in that order. A node between the resistor R5 and the resistor R7 is connected to the feedback pin FB of the power chip U1. The non-inverting input of the comparator U2 is also grounded through a capacitor C4.

An inverting input of the comparator U2 is connected to the power source Vcc through a resistor R9. The inverting input of the comparator U2 is also grounded through a resistor R10. An output of the comparator U2 is connected to a gate of the MOSFET Q6. A source of the MOSFET Q6 is grounded. A drain of the MOSFET Q6 is connected to the power source Vcc through a resistor R11. The drain of the MOSFET Q6 is also connected to a gate of the MOSFET Q7. A source of the MOSFET Q7 is grounded. A drain of the MOSFET Q7 is connected to the power source Vcc through a resistor R12. The drain of the MOSFET Q7 outputs the power good signal PG.

In the embodiment, resistance values of the resistors R9 and R10 are chosen to meet a formula: Vout=Vcc*R10/(R9+R10), where Vout in the formula stands for a voltage output from the phase output pin of the power chip U1, and Vcc stands for a voltage of the power source Vcc.

The power circuit 1 receives an enable signal through the enable pin En, converts the voltage from the power source Vcc, and outputs the converted voltage to the non-inverting input of the comparator U2 through the phase output pin of the power chip U1. When the power circuit 1 is not operating, the voltage of the non-inverting input of the comparator U2 is less than the voltage of the inverting input of the comparator U2. The comparator U2 thus outputs a low level signal, such as logic 0. The MOSFET Q6 is turned off and the MOSFET Q7 is turned on. The power good signal is a low level signal indicating that the power circuit is not ready to operate.

When the power circuit 1 is operating, the voltage of the non-inverting input of the comparator U2 is equal to the voltage of the inverting input of the comparator U2. The comparator U2 thus outputs a high level signal. The MOSFET Q6 is turned on and the MOSFET Q7 is turned off. The power good signal is a high level signal, such as logic 1, indicating that the power circuit 1 is ready to operate or operating normally.

In the embodiment, the MOSFETs Q6 and Q7 are n-channel MOSFETs, and are used as electronic switches. In other embodiments, BJT transistors replace the MOSFETs Q6 and Q7.

While the disclosure has been described by way of example and in terms of a preferred embodiment, it is to be understood that the disclosure is not limited thereto. On the contrary, it is intended to cover various modifications and similar arrangements as would be apparent to those skilled in the art. Therefore, the range of the appended claims should be accorded the broadest interpretation so as to encompass all such modifications and similar arrangements.

What is claimed is:

1. A power good signal generation circuit connected to a power circuit, comprising:
first and second resistors, wherein a first end of the second resistor is connected to a power source through the first resistor, a second end of the second resistor is grounded, and a voltage VR2 at a node between the first and second resistors satisfies a formula VR2=vcc*r2/(r1+r2)=vout, where vcc stands for a voltage output from the power source, r1 stands for a resistance of the first resistor, r2 stands for a resistance of the second resistor, and vout stands for a voltage output by the power circuit when the power circuit operates;
a comparator comprising a non-inverting input connected to the power circuit to receive the voltage output by the power circuit, an inverting input connected to the node between the first and second resistors, and an output outputting a low level signal when a voltage of the non-inverting input is less than a voltage of the inverting input or outputting a high level signal when the voltage of the inverting input is equal to the voltage of the non-inverting input;
a first electronic switch comprising a control terminal connected to the output of the comparator, a first terminal connected to the power source through a third resistor, and a second terminal grounded, wherein when the control terminal receives the high level signal, the first terminal is connected to the second terminal, and when the control terminal receives the low level signal, the first terminal is disconnected from the second terminal; and
a second electronic switch comprising a control terminal connected to the first terminal of the first electronic switch, a first terminal connected to the power source through a fourth resistor, and a second terminal grounded, wherein when the control terminal of the second electronic switch receives a high level signal, the first terminal of the second electronic switch is connected to the second terminal of the second electronic switch, and the first terminal of the second electronic switch outputs a low level power good signal; and when the control terminal of the second switch receives a low level signal, the first terminal of the second electronic switch is disconnected to the second terminal of the second electronic switch, and the first terminal of the second electronic switch outputs a high level power good signal.

2. The power good signal generating circuit of claim 1, wherein the first electronic switch is an n-channel metal oxide semiconductor field effect transistor (MOSFET); a gate, a drain, and a source of the MOSFET are the control terminal, the first terminal, and the second terminal, respectively.

3. The power good signal generating circuit of claim 1, wherein the second electronic switch is an n-channel MOSFET; a gate, a drain, and a source of the MOSFET are the control terminal, the first terminal, and the second terminal, respectively.
